(19) United States
(12) Patent Application Publication
(10) Pub. No.: US 2016/0340216 A1
(43) Pub. Date: Nov. 24, 2016

(54) METHOD FOR REMOVING BORON FROM BORON-CONTAINING WASTE WATER

(71) Applicant: NATIONAL CHUNG SHAN INSTITUTE OF SCIENCE AND TECHNOLOGY, Taoyuan City (TW)

(72) Inventors: YAO-HUI HUANG, TAOYUAN CITY (TW); JUI-YEN LIN, TAOYUAN CITY (TW); CHIA-HSUN LIU, TAOYUAN CITY (TW); SHAO-YU WANG, TAOYUAN CITY (TW); PO-YEN CHEN, TAOYUAN CITY (TW); HUEI-MEI TSAI, TAOYUAN CITY (TW); BIING-JYH WENG, TAOYUAN CITY (TW)

(21) Appl. No.: 14/886,317

(22) Filed: Oct. 19, 2015

(30) Foreign Application Priority Data
May 22, 2015 (TW) 104116385

(51) Int. Cl. C02F 9/00; C02F 1/42; C02F 1/28; C02F 1/72; C02F 1/52

(52) U.S. Cl. CPC C02F 9/00; C02F 1/722; C02F 1/5236; C02F 1/283; C02F 1/42; C02F 1/52; C02F 2001/007

(57) ABSTRACT

A method for removing boron from boron-containing waste water includes performing oxidation/coagulation treatment on the boron-containing waste water in the presence of an oxidant (such as hydrogen peroxide) and a coagulant (such as barium hydroxide) to greatly reduce the boron content of the boron-containing waste water and then removing residual boron therefrom by an ion-exchange resin or reverse osmosis, such that the waste water thus treated meets effluent standards.

### CROSS-REFERENCE TO RELATED APPLICATION

This non-provisional application claims priority under 35 U.S.C. §119(a) on Patent Application No(s). 104116385 filed in Taiwan, R.O.C. on May 22, 2015, the entire contents of which are hereby incorporated by reference.

### FIELD OF TECHNOLOGY

The present invention relates to methods for removing boron from boron-containing waste water and, more particularly, to a method for removing boron from boron-containing waste water, including performing oxidation/coagulation treatment to remove boron from the waste water with boron content of hundreds to thousands of parts per million.

### BACKGROUND

Due to ever-increasing green consciousness, previously-neglected portions of industrial waste water control standards are presently surfacing and are exemplified by the industrial waste water control standards regarding boron. Boron is a trace element indispensable to animals and plants. Nonetheless, excessive boron intake causes premature degeneration to vegetation, turns the leaves yellow, and contributes to symptoms, such as headache and nausea, among human beings. Overly high intake of boron proves harmful to men's reproductive system and attributable to renal failure-induced death. However, traces of boron-containing compounds are often present in necessities, such as glass, ceramics, porcelains, enamel, bleaching power, laundry detergents, fertilizers, and insecticides, indicating that boron is widely used in consumer-oriented industries. A huge amount of boric acid is used in the manufacturing processes carried out by TFT-LCD manufacturers; as a result, it contributes to waste water which contains high boron content. Water pollution related laws currently in force set forth a standard discharge level of 1 mg/L. In 2011, the WHO adopted a drinking water standard with a recommended boron level of less than 2.4 mg/L.

Past research papers about treatment of boron-containing waste water focus on the following techniques: chemical coagulation, ion-exchange resin, and reverse osmosis. In this regard, chemical coagulation is disclosed in: Chang, Y H., N. C. Burkank Jr., “The removal of boron from incinerator Quench water: Hydrous metallic oxides versus ion-specific resin,” Proc. of the 32^{nd} Industrial Waste Conference, Purdue University, pp. 415-427 (1977); and Wong J. M., “Boron control in power plant-reclaimed water for portable reuse,” Environmental Progress, Vol. 3, No. 1, pp. 5-11 (1984). Furthermore, ion-exchange resin is disclosed in: Peterson W. D., “Removal of boron from water,” U.S. Pat. No. 3,856,670 (1975); Nadav N., “Boron removal from seawater reverse osmosis permeate utilizing selective ion exchange resin,” Desalination, V. 124, No. 1-3, pp. 131-135 (1999); and Simonnot M., et. Al., “Boron removal from drinking water with a boron selective resin: is the treatment really selective?” Water Research, Vol. 34, No. 1, pp. 109-116 (2000). Reverse osmosis is disclosed in: Magara, Y; Tabata, A.; Kohki, M.; Kawasaki, M.; Hirose, M., “Development of boron reduction system for seawater desalination,” Desalination, Vol. 118, No. 1-3, pp. 25-34 (1998). Low-concentration waste water, such as industrial waste water, which ranges from several ppm to dozens of ppm of boron content, is treated in order to meet the discharge standard of B<1 mg/L. Desalination involves reducing 5 ppm of boron content to meet drinking water standards. Boron removal is also required in the manufacturing of ultra-pure water to process water which contains dozens of ppm of boron content. In addition high-concentration boron-containing waste water can be treated by evaporation which in turn requires a large amount of heat, thereby adding to costs, not to mention that traces of boron still exist in condensed water and thus need to be processed further.

The boron content of boron-containing waste water discharged from power plants ranges from hundreds of ppm to thousands of ppm. Unless also simultaneously treated with a low-concentration treatment technique (such as ion-exchange resin technique), it will be difficult for boron-containing waste water to meet the discharge standard of B<1 mg/L at the end of the process of treating the boron-containing waste water with boron content of hundreds of ppm by a conventional coagulation technique in the presence of a coagulant. The joint use of the conventional coagulation technique and the ion-exchange resin technique will prove useless in treating boron-containing waste water with boron content of thousands of ppm.

Drawbacks manifested by the aforesaid conventional techniques in treating boron-containing waste water discharged from power plants are as follows:
1. Chemical Coagulation: it is ineffective in reducing the concentration of residual boron and meeting the discharge standard thereof, because of a limit of removal efficiency.
2. Ion-exchange Resin: it incurs a high configuration cost and operating expense; the resultant high-concentration concentrated waste water poses a problem with secondary pollution; and, it is ineffective in treating high-concentration boron-containing waste water, because of an increase of the generation frequency and a vicious cycle of an increasingly large amount of regenerated waste water.
3. Reverse Osmosis: reverse osmosis proves ineffective in treating waste water at pH 7, and thus the pH value of the waste water is usually increased to 10 or above in order for reverse osmosis to work well; however, most reverse osmosis membranes are predisposed to property degeneration at a high pH value; furthermore, even when preceded by a pre-treatment process, no reverse osmosis process can eliminate the effect of filth and suspended solids on waste water discharged from power plants, because the waste water discharged from power plants typically manifests hardness arising from its high calcium content, high magnesium content, and the like.
4. Evaporation: high-concentration boron-containing waste water can be treated by evaporation in the presence of a large amount of heat, thereby adding to costs, not to mention that traces of boron from dozens of ppm to hundreds of ppm still exist in condensed water and thus need to be further processed with a low-boron-content waste water treatment unit.

U.S. Pat. No. 6,039,789, entitled Removal of boron and fluoride from water, discloses an integrated process which entails: (step 1) removing boron and fluoride compounds from waste water; and, (step 2) extracting gold from sulfide-containing or sulfur-containing gold ores by sludge produced in step 1, wherein the boron and fluoride compounds are removed by a magnesium-containing hydroxide. U.S. Pat. No. 5,925,255, entitled Method and apparatus for high efficiency reverse osmosis operation, discloses a method for treating ultra-pure water with a RO membrane technique, including eliminating hardness alkalinity by a pre-treatment process and then increasing the pH value to at least 10.5 in order to remove boron, silicon, TOC and the like. U.S. Pat. No. 4,800,042, entitled Radioactive waste water treatment, discloses a process of reducing the quantity of nuclear waste, and the process involves adding an alkaline to waste water in order to adjust its pH value before allowing the waste water to evaporate and concentrate, adding calcium hydroxide to the concentrate, eventually allowing the concentrate to evaporate, solidifying the concentrate with cement, or allowing the concentrate to evaporate and dry.

Hence, it is necessary to develop a method of treating boron-containing waste water to strike a balance between protecting the environment and treating high-concentration boron-containing waste water efficiently, reduce the boron content efficiently, remove the residual low-concentration part by ion-exchange resin or reverse osmosis, and treat the high-concentration boron-containing waste water, such as waste water discharged from power plants, until it meets effluent standards.

### SUMMARY

It is an objective of the present invention to provide a method for removing boron from boron-containing waste water. The method is effective in removing boron from the waste water with boron content of hundreds to thousands of parts per million. The method requires just a single step of coagulation to thereby simplify the treatment process flow, thus enhancing the treatment efficiency.

The method of the present invention aims to remove boron from boron-containing waste water and involves allowing boron ions in the boron-containing waste water to react with a coagulant at least selected from a barium-containing compound at any pH value from 8 to 14 and in the presence of an oxidant, so as to form boron salt suspended solid particles. In a preferred embodiment, the method of the present invention comprises the steps of: i) performing an oxidation/coagulation treatment on the boron-containing waste water, such that boron ions in the boron-containing waste water form boron salt suspended solid particles; and ii) performing solid/liquid separation on the boron-containing waste water treated in step i) to thereby obtain a liquid with reduced boron content and a boron-containing sludge, wherein the oxidation/coagulation treatment enables the boron ions in the boron-containing waste water to react with a coagulant inclusive of a group IIA metal-containing compound at any pH value from 8 to 14 and in the presence of an oxidant, so as to form the boron salt suspended solid particles.

In a preferred embodiment, the method of the present invention further comprises the step of iii) introducing the liquid with reduced boron content in step ii) into an ion-exchange resin, such that the boron ions in the liquid are adsorbed to the ion-exchange resin, so as to obtain a treated water which has passed through the ion-exchange resin and has a boron ion concentration lower than a predetermined level, or passing the liquid with reduced boron content in step ii) through a reverse osmosis membrane to remove the boron ions from the liquid, so as to obtain a treated water which has passed through the reverse osmosis membrane and has a boron ion concentration lower than a predetermined level.

Preferably, the method of the present invention is further characterized in that, before step iii), the liquid with reduced boron content in step ii) is introduced into a stabilization tank to thereby remove from the liquid the suspended solids (SS) and traces of the oxidant, so as to obtain a stabilization tank effluent adapted to be treated with the ion-exchange resin or the reverse osmosis membrane. Activated carbon is contained in the stabilization tank.

In a practicable embodiment, the group IIA metal-containing compound is a barium-containing compound, such as barium hydroxide, and the molar ratio Ba/B of the dosage of the coagulant of the barium-containing compound to boron (B) equals 1-6. The oxidant is hydrogen peroxide. The dosage of the hydrogen peroxide equals 1 g/L to 10 g/L.

The other objectives, features, and advantages of the present invention are hereunder illustrated with preferred embodiments in conjunction with the accompanying drawings.

### BRIEF DESCRIPTION

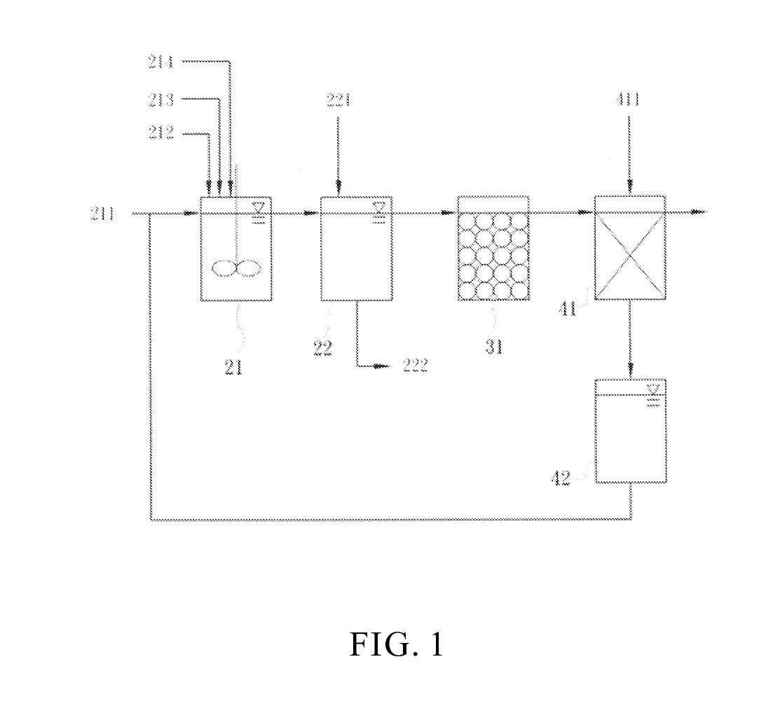

FIG. 1 is a block-diagram flow chart of a method for removing boron from boron-containing waste water according to the present invention;

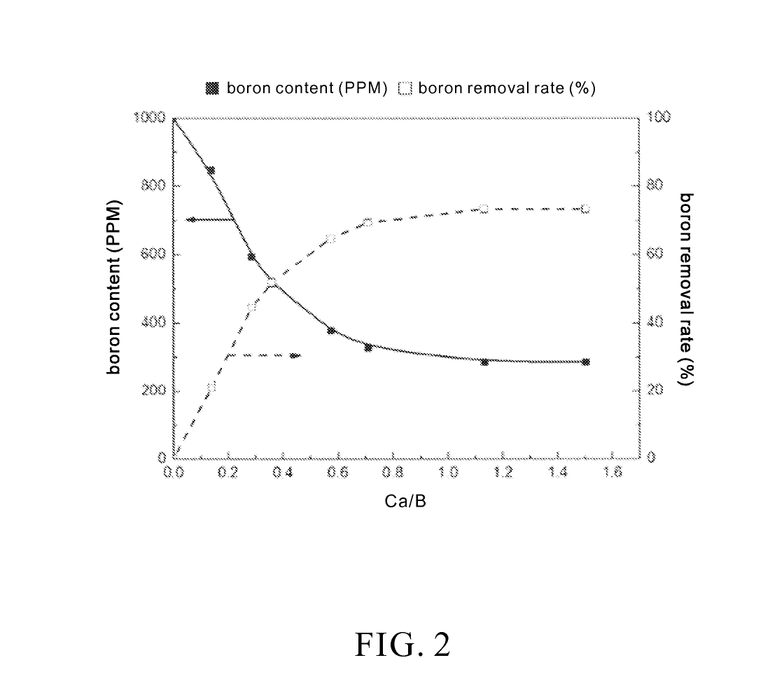

FIG. 2 is a schematic view of the effect of different Ca/B on boron (B) removal rate in the presence of a coagulant of calcium hydroxide (Ca(OH)₂) according to a comparative embodiment of the present invention, wherein C_{B,i}=1000 mg/L, H₂O₂/B=1, pH_{f}=9;

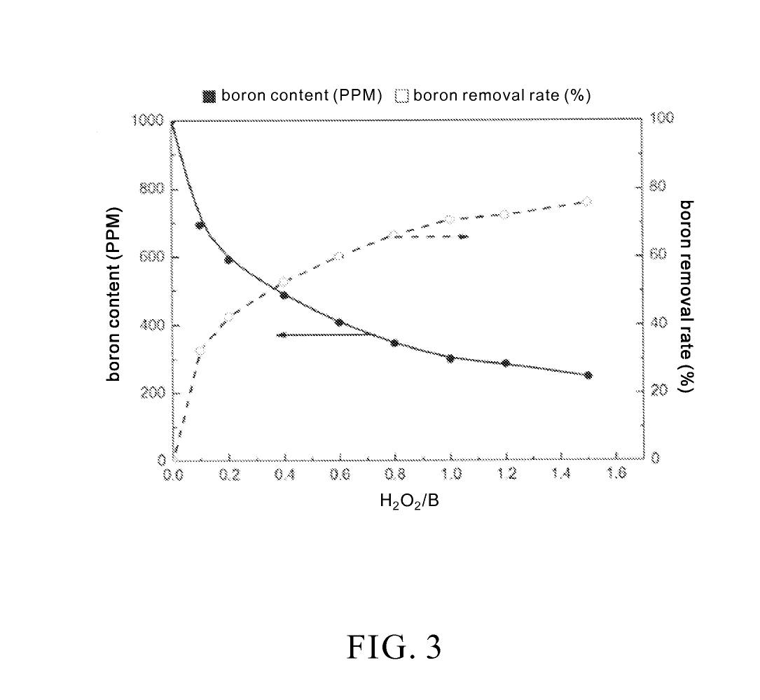

FIG. 3 is a schematic view of the effect of different H₂O₂/B on boron (B) removal rate in the presence of a coagulant of calcium hydroxide (Ca(OH)₂) according to a comparative embodiment of the present invention, wherein C_{B,i}=1000 mg/L, Ca/B=1, pH_{f}=9;

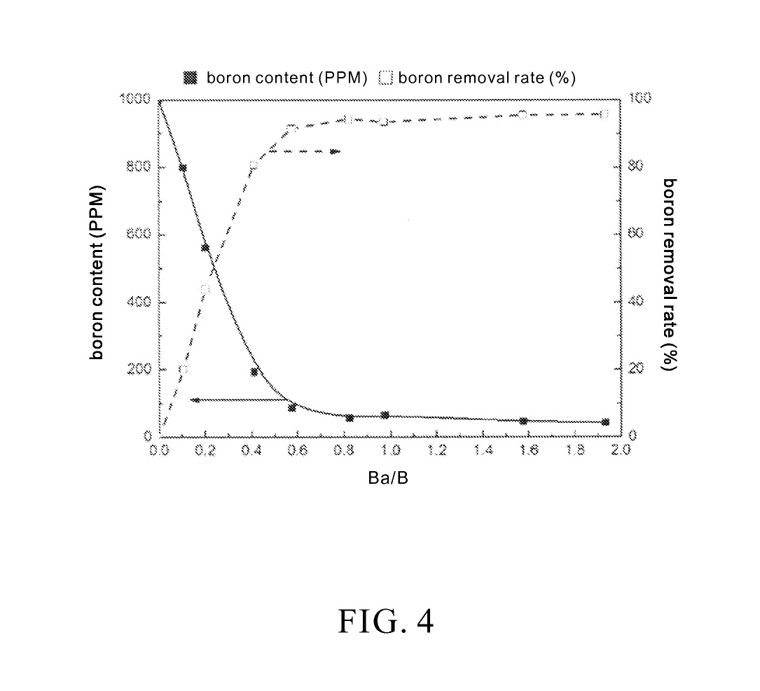

FIG. 4 is a schematic view of the effect of different Ba/B on boron (B) removal rate according to an embodiment of the present invention, wherein C_{B,i}=1000 mg/L, H₂O₂/B=1, pH_{f}=9;

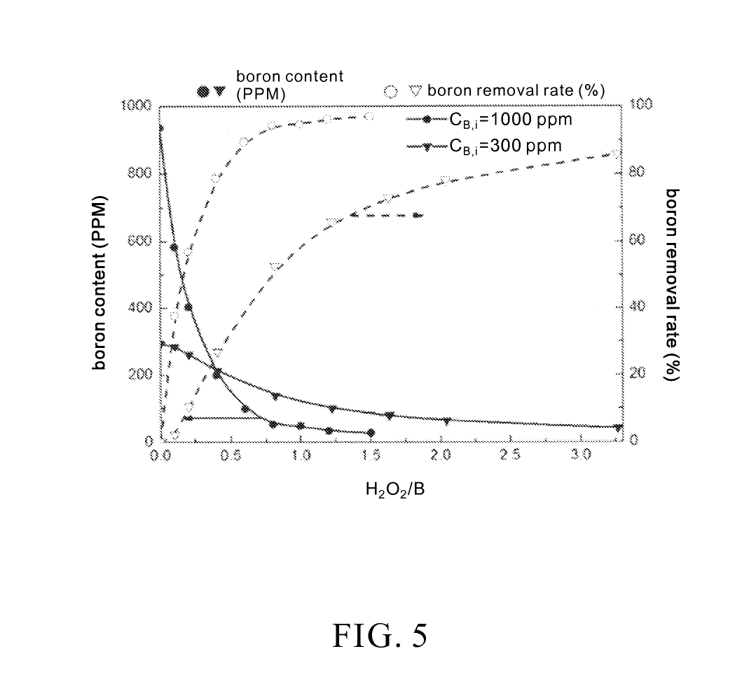

FIG. 5 is a schematic view of the effect of different H₂O₂/B on boron (B) removal rate according to another embodiment of the present invention, wherein C_{B,i}=300 mg/L and 1000 mg/L, Ba/B=1, pH_{f}=9;

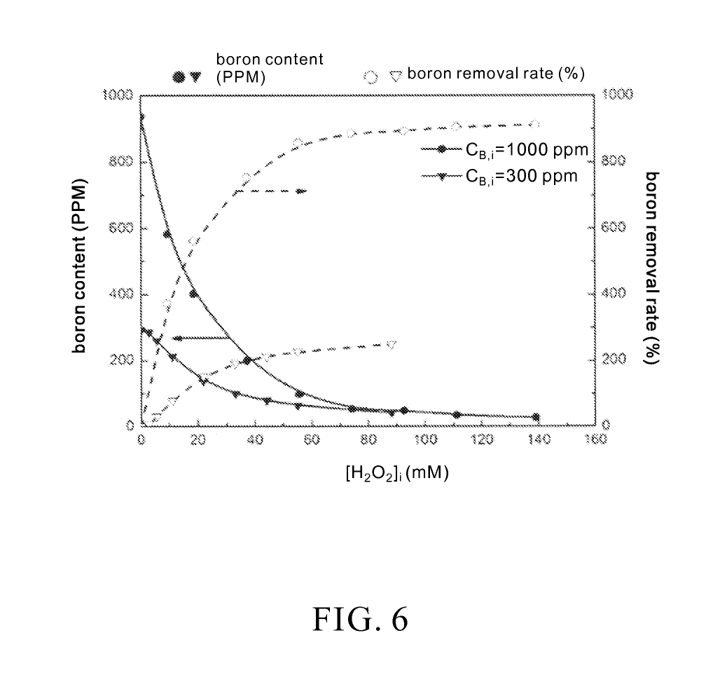

FIG. 6 is a schematic view of the effect of different H₂O₂ concentrations on boron (B) removal rate according to another embodiment of the present invention, wherein C_{B,i}=300 mg/L and 1000 mg/L, Ba/B=1, pH_{f}=9; and

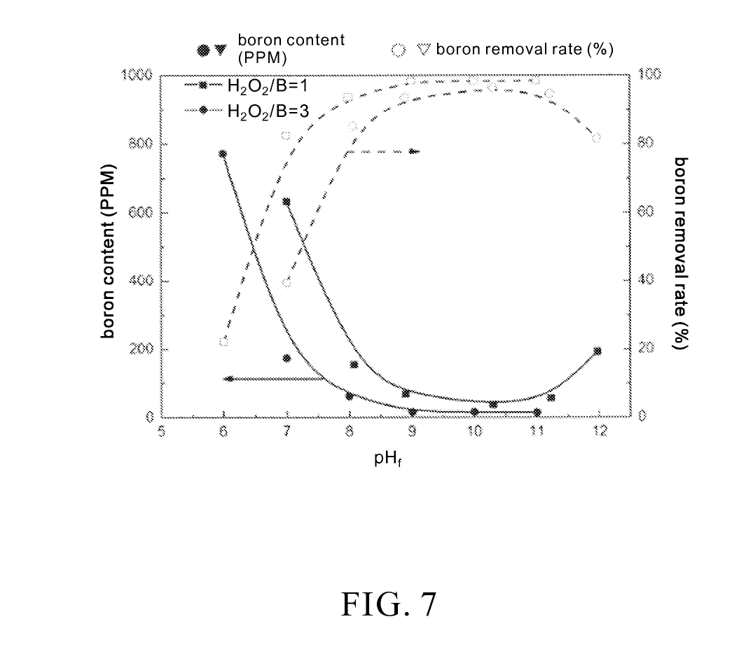

FIG. 7 is a schematic view of the effect of different H₂O₂/B and pH_{f} on boron (B) removal rate according to another embodiment of the present invention, wherein C_{B,i}=1000 mg/L, Ba/B=1.

### DETAILED DESCRIPTION

The present invention essentially puts forth a method for removing boron from boron-containing waste water. The method requires just a single step of oxidation/coagulation treatment using hydrogen peroxide and a coagulant to efficiently reduce the boron content of the boron-containing waste water, then remove the residual low-concentration part by ion-exchange resin or reverse osmosis, and treat the high-concentration boron-containing waste water, such as waste water discharged from power plants, until it meets effluent standards, thereby simplifying the treatment process flow and enhancing the treatment efficiency.

Referring to FIG. 1, the method according to a preferred embodiment of the present invention comprises the steps of: (a) introducing an influent (boron-containing waste water 211) into an oxidation/coagulation tank 21, introducing into the oxidation/coagulation tank 21 a coagulant 213 and an alkaline 212, adjusting the pH value to 8-14, introducing into the oxidation/coagulation tank 21 a hydrogen peroxide 214 to allow an oxidation/coagulation reaction to occur for an appropriate period of time; (b) delivering the waste water resulting from the oxidation/coagulation reaction which occurred in the oxidation/coagulation tank 21 to a solid/liquid separation device 22, introducing into the solid/liquid separation device 22 a polymer flocculant 221 to allow solid/liquid separation to take place; (c) introducing the residual low-concentration boron-containing waste water discharged from the solid/liquid separation device 22 into a stabilization tank 31 which contains activated carbon and allowing the residual low-concentration boron-containing waste water to stay in the stabilization tank 31 for an appropriate period of time, for example, 10 to 60 minutes to not only remove suspended solids (SS) from the waste water but also residual hydrogen peroxide 214 from the waste water with a view to facilitating the subsequent operation of an ion-exchange resin tank 41 and preventing the properties of the ion-exchange resin from oxidation-induced damage, and eventually introducing the residual low-concentration boron-containing waste water discharged from the solid/liquid separation device 22 into the ion-exchange resin tank 41 to carry out boron removal; and (d) introducing the waste water discharged from the stabilization tank 31 into the ion-exchange resin tank 41 to carry out boron removal and discharging the waste water discharged from the ion-exchange resin tank 41.

Upon saturation of the adsorption taking place in the ion-exchange resin tank 41, the waste water discharged from the stabilization tank 31 is introduced into a parallel additional ion-exchange resin tank (not shown) to carry out boron removal, and then a regenerant 411 is introduced into the ion-exchange resin tank 41 to allow regeneration to take place. The regenerated waste water thus produced is introduced into a regeneration concentrate storage tank 42 and then introduced, in a quantitatively constant manner, into the oxidation/coagulation tank 21 to mix with the high-concentration boron-containing original waste water for subsequent treatment. Hence, the method of the present invention does not lead to secondary pollution of high-concentration boron-containing waste water.

According to the present invention, the coagulant used in step (a) is a barium-containing compound (inclusive of a group IIA metal-containing compound), an iron-containing compound, or a mixture thereof. In this preferred embodiment, the coagulant is a barium-containing compound, such as barium hydroxide, and the molar ratio Ba/B of the dosage of the coagulant to boron (B) equals 1-6.

The hydrogen peroxide used in step (a) can also be replaced with any other coagulant, such as any other peroxide or sodium hypochlorite. The dosage of the hydrogen peroxide 214 equals 1 g/L to 10 g/L. The solid/liquid separation technique used in step (b) of the present invention involves introducing the waste water discharged in step (a) into a slow mix tank or introducing the polymer flocculant 221 into the waste water discharged in step (a) by infusion, such that the tiny suspended solid particles produced in the oxidation/coagulation tank 21 flocculate to become large gelatinous particles before the resultant large gelatinous particles undergo solid/liquid separation in the solid/liquid separation device 22 to separate a clarified liquid and a sludge 222 from each other. The solid/liquid separation device 22 in use includes a precipitation tank, a flotation tank, a centrifuge, or a furnace-style sludge hydro-extractor. The preferred embodiments of the present invention are not restrictive of the polymer flocculant 221 of the present invention, but the polymer flocculant 221 of the present invention is preferably an anionic polymer flocculant.

The sludge discharged in step (b) of the method according to the present invention can be recycled by a technique which involves introducing into a sludge storage tank (not shown) the sludge 222 separated by the solid/liquid separation technique used in step (b) and then introducing the sludge 222, in a quantitatively constant manner, to the oxidation/coagulation tank 21. Since the sludge discharged in step (b) contains little boron, it is feasible to mix the sludge discharged in step (b) with the waste water which contain much boron such that the mixture can undergo oxidation/coagulation once more, so as to reduce the yield of the sludge 222. According to the present invention, the boron content of the effluent discharged from the ion-exchange resin tank 41 in step (d) is less than 1 mg/L.

### Comparative Embodiment 1

In this comparative embodiment, waste water of an influent with boron content (B in) of 1000 mg/L is tested by an oxidation/coagulation technique using hydrogen peroxide (H₂O₂) as the oxidant 214 and calcium hydroxide (Ca(OH)₂) as the coagulant 213, at a pH 9. The result of the test is shown in FIG. 2 and described as follows: the optimal boron removal rate (B rem) is 68-72%, but the residual concentration is still as high as 300 mg/L. The boron removal rate (B rem) is calculated as follows: the boron content of an influent minus the boron content of an effluent, then the difference is divided by the boron content of the influent, and eventually the quotient is multiplied by 100%, wherein the boron analysis technique adopted is NIEAW404.50A, the water quality assessment technique recommended by Taiwan's Environmental Protection Administration.

### Comparative Embodiment 2

In this comparative embodiment, waste water of an influent with boron content (B in) of 1000 mg/L is tested by an oxidation/coagulation technique using hydrogen peroxide (H₂O₂) as the oxidant 214, calcium hydroxide (Ca(OH)₂) as the coagulant 213, and different H₂O₂ concentrations as well as a coagulant dosage of Ca/B=1, at a pH 9. The result of the test is shown in FIG. 3 and described as follows: the optimal boron removal rate (B rem) is 67-75%, but the residual concentration is still as high as 250-300 mg/L.

### Embodiment 1

In this embodiment, waste water of an influent with boron content (B in) of 1000 mg/L is tested by an oxidation/coagulation technique using a coagulant of Ba(OH)₂, H₂O₂, and at pH 9, according to the method of the present invention, as shown in FIG. 1. The result of the test is shown in FIG. 4. Referring to FIG. 4, the boron (B) removal rate (B rem) is at least 95% under the condition of Ba/B=0.2-2.0 and H₂O₂/B=1 in the oxidation/coagulation tank. By contrast, the comparative embodiment 1 shown in FIG. 2 yields a boron (B) removal rate (B rem) of less than 80% when the coagulant is Ca(OH)₂. Hence, the method of the present invention, which uses a coagulant inclusive of a barium compound, surpasses the prior art in terms of the boron removal rate and thus can reduce the boron content (B out) of the treated water to less than 50 mg/L.

### Embodiment 2

In this embodiment, waste water of an influent with boron content (B in) of 300 mg/L and 1000 mg/L is tested by an oxidation/coagulation technique using a coagulant with Ba/B=1, H₂O₂ of different concentrations, and at pH 9, according to the method of the present invention, as shown in FIG. 1. The result of the test is shown in FIG. 5 and FIG. 6. Referring to FIG. 5, the boron content (B out) of the treated water is always reduced to less than 50 mg/L under the condition of Ba/B=1 and H₂O₂/B=0.1-3.3 in the oxidation/coagulation tank. Referring to FIG. 6, the boron content (B out) of the treated water is always reduced to less than 50 mg/L under the condition of Ba/B=1 and H₂O₂ concentrations of 5-140 mM in the oxidation/coagulation tank. By contrast, the comparative embodiment 2 shown in FIG. 3 yields a boron (B) removal rate (B rem) of less than 80% when the coagulant is Ca(OH)₂. Hence, the method of the present invention, which uses a coagulant inclusive of a barium compound, surpasses the prior art in terms of the boron removal rate and thus can reduce the boron content (B out) of the treated water to less than 50 mg/L.

### Embodiment 3

In this embodiment, waste water of an influent with boron content (B in) of 1000 mg/L is tested by an oxidation/coagulation technique using a coagulant with Ba/B=1, H₂O₂/B=1, H₂O₂/B=3, and at variable pH values, according to the method of the present invention, as shown in FIG. 1. The result of the test is shown in FIG. 7. Referring to FIG. 7, the boron content (B out) of the treated water is further reduced to less than 20 mg/L (see Table 1 below) under the condition of pH 8.9-11.2, Ba/B=1 and H₂O₂/B=3 in the oxidation/coagulation tank. Hence, the method of the present invention, which uses a coagulant inclusive of a barium compound, surpasses the prior art which discloses a coagulant inclusive of a calcium compound in terms of the boron removal rate and thus can reduce the boron content (B out) of the treated water to less than 20 mg/L.

TABLE 1
Removal rate (C_{B,i} = 1000 mg/L, H₂O₂/B = 1) and residual
concentrations of Ba and B at different pH_{f}

| H₂O₂/B = 1 | | | | H₂O₂/B = 3 | | |
|---|---|---|---|---|---|---|
| | C_{B} | C_{Ba} | B | | C_{B} | B |
| pH_{f} | (mg/L) | (mg/L) | Removal (%) | pH_{f} | (mg/L) | Removal (%) |
| 6.6 | 923 | 11700 | 11.9 | 6 | 773 | 22.1 |
| 7.0 | 633 | 10500 | 39.6 | 7 | 174 | 82.5 |
| 8.1 | 154 | 7770 | 85.3 | 8 | 63 | 93.6 |
| 8.9 | 68 | 6560 | 93.5 | 9 | 16 | 98.4 |
| 10.3 | 38 | 6110 | 96.4 | 10 | 16 | 98.4 |
| 11.2 | 57 | 5610 | 94.6 | 11 | 15 | 98.5 |
| 12.0 | 193 | 5380 | 81.6 | | | |

### Embodiment 4

In this embodiment, water treated by the oxidation/coagulation tank is used as an influent for performing a test on treating boron (B) with ion-exchange resin. The ion-exchange resin used, i.e., Amberlite ion-exchange resin (Model No. IRA-743), which was purchased from the US-based Rohm & Haas, features influent boron content of 17 mg/L, an influent flow rate of 10 resin volume units per hour (BV/h), a stay duration of 6 minutes, and pH 10-11. The result of the test shows that, given an influent flow rate of less than 100 BV/h, the effluent boron content is quite low and is actually too low to be detected.

The present invention is illustrated above with specific embodiments, and thus plenty of equivalent variations or changes can be made to the aforesaid embodiments in accordance with the technical features of the present invention. Hence, persons skilled in the art should understand that all equivalent modifications and replacements made to the aforesaid embodiments should fall within the scope of the claims of the present invention.

What is claimed is:

1. A method for removing boron from boron-containing waste water, comprising the steps of:
i) performing an oxidation/coagulation treatment on the boron-containing waste water, such that boron ions in the boron-containing waste water form boron salt suspended solid particles; and
ii) performing solid/liquid separation on the boron-containing waste water treated in step i) to thereby obtain a liquid with reduced boron content and a boron-containing sludge,
wherein the oxidation/coagulation treatment enables the boron ions in the boron-containing waste water to react with a coagulant inclusive of a group IIA metal-containing compound at any pH value from 8 to 14 and in presence of an oxidant, so as to form the boron salt suspended solid particles.

2. The method for removing boron from boron-containing waste water as recited in claim 1, further comprising the step of iii) introducing the liquid with reduced boron content in step ii) into an ion-exchange resin or passing the liquid with reduced boron content in step ii) through a reverse osmosis membrane to remove the boron ions from the liquid and thus obtain a treated water with a boron ion concentration lower than a predetermined level.

3. The method for removing boron from boron-containing waste water as recited in claim 1, wherein, before step iii), the liquid with reduced boron content in step ii) is introduced into a stabilization tank to thereby remove suspended solids (SS) and traces of the oxidant from the liquid, so as to obtain a stabilization tank effluent adapted to be treated with one of the ion-exchange resin and the reverse osmosis membrane.

4. The method for removing boron from boron-containing waste water as recited in claim 3, wherein activated carbon is contained in the stabilization tank.

5. The method for removing boron from boron-containing waste water as recited in claim 1, wherein the oxidant is hydrogen peroxide, and the group IIA metal-containing compound is barium hydroxide.

6. The method for removing boron from boron-containing waste water as recited in claim 5, wherein a molar ratio Ba/B of a dosage of the coagulant to boron (B) equals 1-6, with the oxidant being hydrogen peroxide, wherein a dosage of the hydrogen peroxide equals 1 g/L to 10 g/L.

7. The method for removing boron from boron-containing waste water as recited in claim 5, wherein a molar ratio Ba/B of a dosage of the coagulant to boron (B) equals 0.2-2.0, using hydrogen peroxide as the oxidant, and a molar ratio H₂O₂/B of a dosage of the hydrogen peroxide to boron (B) equals 1.

8. The method for removing boron from boron-containing waste water as recited in claim 5, wherein a molar ratio Ba/B of a dosage of the coagulant to boron (B) equals 1, using hydrogen peroxide as the oxidant, and a molar ratio H₂O₂/B of a dosage of the hydrogen peroxide to boron (B) equals 0.1-3.3.

9. The method for removing boron from boron-containing waste water as recited in claim 5, wherein a molar ratio Ba/B of a dosage of the coagulant to boron (B) equals 1, using hydrogen peroxide as the oxidant, and the hydrogen peroxide concentrations equal 5-140 mM.

10. The method for removing boron from boron-containing waste water as recited in claim 1, wherein a molar ratio Ba/B of a dosage of the coagulant to boron (B) equals 1, using hydrogen peroxide as the oxidant, and a molar ratio H₂O₂/B of a dosage of the hydrogen peroxide to boron (B) equals 3.

11. The method for removing boron from boron-containing waste water as recited in claim 2, wherein the solid/liquid separation in step ii) comprises introducing a polymer flocculant into the boron-containing waste water treated in step i), such that the suspended solid particles therein flocculate to become large gelatinous particles, and then a liquid and a sludge are separated with one of a precipitation tank, a flotation tank, a centrifuge, and a furnace-style sludge hydro-extractor.

12. The method for removing boron from boron-containing waste water as recited in claim 2, wherein, after the adsorption by the ion-exchange resin has become saturated in step iii), a regenerant is introduced into the ion-exchange resin to allow regeneration to take place, such that a regenerated waste water thus produced is introduced into a regeneration concentrate storage tank and then introduced, in a quantitatively constant manner, into the oxidation/coagulation tank in step i) to undergo the oxidation/coagulation treatment together with the boron-containing waste water.

13. The method for removing boron from boron-containing waste water as recited in claim 1, wherein a boron-containing sludge obtained in step ii) is introduced into a sludge storage tank, and then the sludge is introduced, in a quantitatively constant manner, to the oxidation/coagulation tank in step i) to undergo the oxidation/coagulation treatment together with the boron-containing waste water.
